(19) United States
(12) Patent Application Publication
(10) Pub. No.: US 2026/0269460 A1
(43) Pub. Date: Sep. 10, 2026

(54) METHODS AND APPARATUS TO MOUNT AN ANTENNA TO A VEHICLE

(71) Applicant: The Boeing Company, Arlington, VA (US)

(72) Inventors: Drew-Daniel Keefe, Maple Valley, WA (US); Linh Thuy Luong, Houston, TX (US); James Daniel Davis, Norman, OK (US); Samuel Phillip Zitterkob, Norman, OK (US); Larry Allen Eck, Jones, OK (US); Travis Wesley Scafe, Oklahoma City, OK (US); Irfan Manzoor Ahmed, Wichita, KS (US); Roberto Alejandro Castaneda, Arcadia, OK (US); Jay Michael Gramling, Edmond, OK (US)

(21) Appl. No.: 19/070,098

(22) Filed: Mar. 4, 2025

(51) Int. Cl. H01Q 1/32; H01Q 1/02

(52) U.S. Cl. CPC H01Q 1/3208; H01Q 1/02

(57) ABSTRACT

Methods and apparatus for securing an antenna to a vehicle are disclosed. An example apparatus for coupling an antenna to a vehicle includes, a baseplate to receive the antenna including a plurality of mounting points, a first cavity including a first inlet and an outlet, a second cavity including a second inlet, an opening between the first cavity and the second cavity, and a fairing to be attached to the baseplate to surround a peripheral edge of the antenna, the fairing including gussets configured to control air flow from the first and second inlets to the outlet.

### GOVERNMENT INTEREST

This invention was made with Government support of the United States. The Government of the United States may have certain rights in this invention.

### FIELD OF THE DISCLOSURE

This disclosure relates generally to mounting of antennas and, more particularly, to mounting an antenna to a vehicle.

### BACKGROUND

Antennas are used in a wide variety of applications, including vehicle applications. With the improvement of satellite technologies, such as phased array antennas offering high speeds, lower latency, and broader coverage, a need has developed in industry to incorporate these antennas in high stress environments such as those seen by aircraft. Protecting antennas from environmental hazards is important when improving performance and reliability of the vehicle.

### BRIEF DESCRIPTION OF THE DRAWINGS

FIG. 1A is a view of an example apparatus for coupling an antenna to a vehicle including a fairing and baseplate constructed in accordance with the teachings herein.

FIG. 1B is a cross-sectional view of the example apparatus of FIG. 1A taken along the section line A-A.

FIG. 2 is a view of the example apparatus of FIGS. 1A and 1B with the fairing removed to show the antenna assembly resting on a structure of the underlying baseplate.

FIG. 3 is a view of the underside of the fairing and antenna assembly of FIG. 1A.

FIG. 4 is a view of an example aircraft including the apparatus of FIGS. 1A and 1B.

FIG. 5 provides a detailed view of a topside of the aircraft of FIG. 4 including the apparatus.

FIG. 6 is a flowchart of a method for securing an antenna to an aircraft in accordance with the teachings herein.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### SUMMARY

An example apparatus for coupling an antenna to a vehicle includes, a baseplate to receive the antenna including a plurality of mounting points, a first cavity including a first inlet and an outlet, a second cavity including a second inlet, an opening between the first cavity and the second cavity, and a fairing to be attached to the baseplate to surround a peripheral edge of the antenna, the fairing including gussets configured to control air flow from the first and second inlets to the outlet.

An example aircraft including a fuselage including mounting points, a baseplate mounted to the fuselage via the mounting points, a satellite antenna fastened to the baseplate, a first cavity including a first inlet and an outlet, a second cavity including a second inlet, an opening between the first cavity and the second cavity, and a fairing to be attached to the baseplate to surround a peripheral edge of the antenna, the fairing including gussets configured to control air flow from the first and second inlets to the outlet.

An example method for securing an antenna to an aircraft includes, mounting a baseplate to a fuselage of the aircraft, securing the antenna to the baseplate, forming a first cavity including a first inlet and an outlet, forming a second cavity including a second inlet, forming an opening between the first cavity and the second cavity, and attaching a fairing to the baseplate to surround a peripheral edge of the antenna, the fairing including gussets configured to control air flow from the first and second inlets to the outlet.

### DETAILED DESCRIPTION

With recent developments of satellite antennas there has been a need in industry to incorporate these antennas into vehicles. In certain applications, such as in aircraft, satellite antennas may experience a particularly stressful environment. In military applications, the aircraft is more likely to experience fuel spillage events that could affect an antenna mounted to the aircraft. Fuel spillage/vapors can ingress into electrically powered portions of the antenna where a spark could ignite and cause an explosion that is hazardous to the safety of the airplane. A damaged antenna could be ejected from the aircraft and cause damage to the aircraft or to its surrounding environment. An antenna may be damaged due to delta pressures exceeding the capability of the antenna in a multitude of conditions such as normal flight, cabin decompression, or a bird strike. Effective designs must balance air exchanges within the installation cabin to evacuate fuel spillage/vapors and delta pressures affecting the antenna.

Some current solutions may not sufficiently protect the antenna from delta pressures experienced by the antenna or fuel spillage events. One known solution passively protects against cabin decompression events by ensuring a crack in the fuselage does not grow to vent into the satellite antenna cavity. However, this solution does not satisfy the certification requirements of all platforms, and may not satisfy the safety and reliability needs of military applications. One other known solution utilizes a relatively large mounting structure and would interfere with other military equipment mounted on the fuselage of the aircraft. This known solution seals the entire satellite antenna cavity increasing the delta pressure experienced by the portion of the satellite antenna exposed to the air stream. Increasing the delta pressure experienced by the antenna can cause failure of high capability satellite antennas, which are more sensitive to the delta pressure.

Neither of the foregoing known solutions protects the satellite antenna from fuel spillage. Fuel spillage can occur in air-to-air refueling events, which are common in military applications. Fuel spillage events could lead to explosions or fire events inside the satellite antenna cavity if the fuel is not evacuated. Five air exchanges per minute or greater is required to effectively evacuate any fuel or fuel vapors that may be in the satellite antenna cavity. It is also noted that antennas generate a large amount of heat, which must be dissipated by the mounting solution to allow for proper operation of the satellite antenna and protect the load carrying capability of the surrounding structure.

The examples disclosed herein enable mounting of an antenna to a vehicle including a baseplate and a fairing including an inlet, outlet, and gussets to control airflow from the inlet to the outlet. The examples described herein enable protection of the satellite antenna mounted to the fuselage of an aircraft, while providing sufficient air exchanges to evacuate fuel and fuel vapors and maintaining a small footprint. The examples disclosed herein enable mounting of an antenna to various vehicles including aircraft.

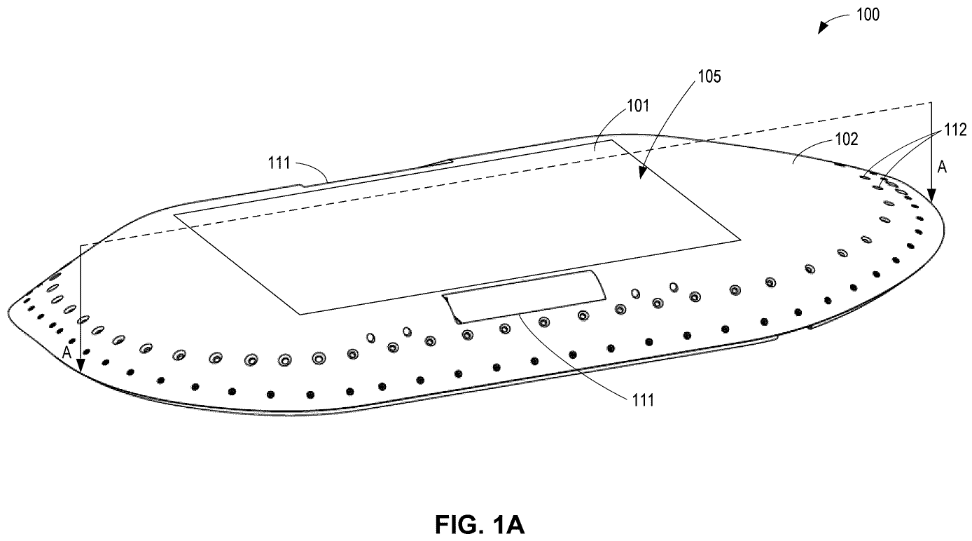

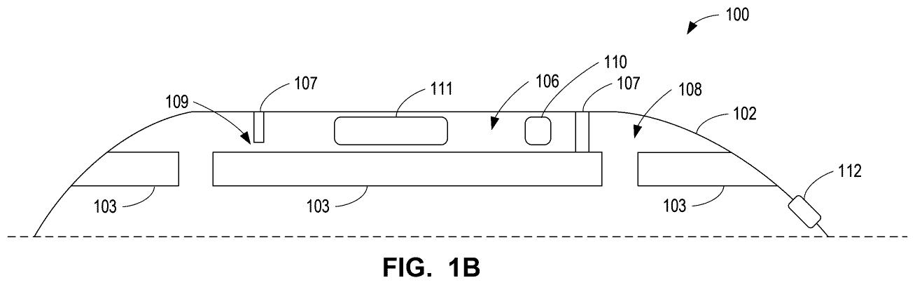

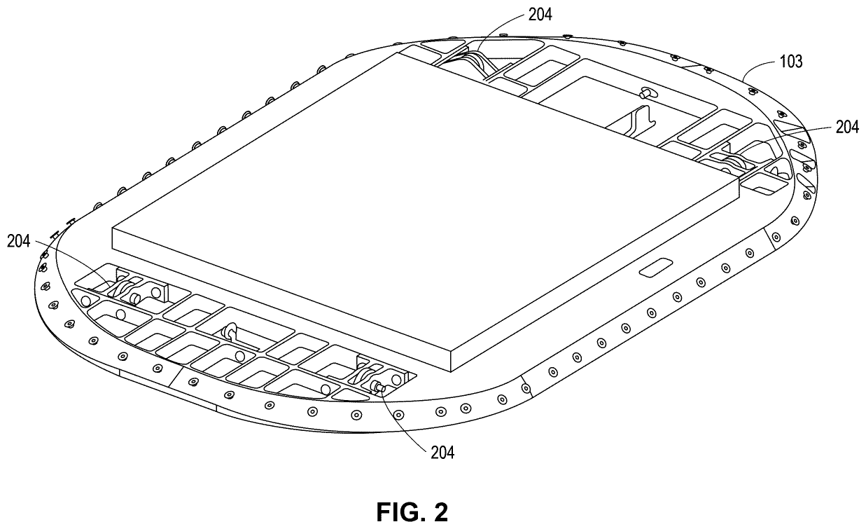

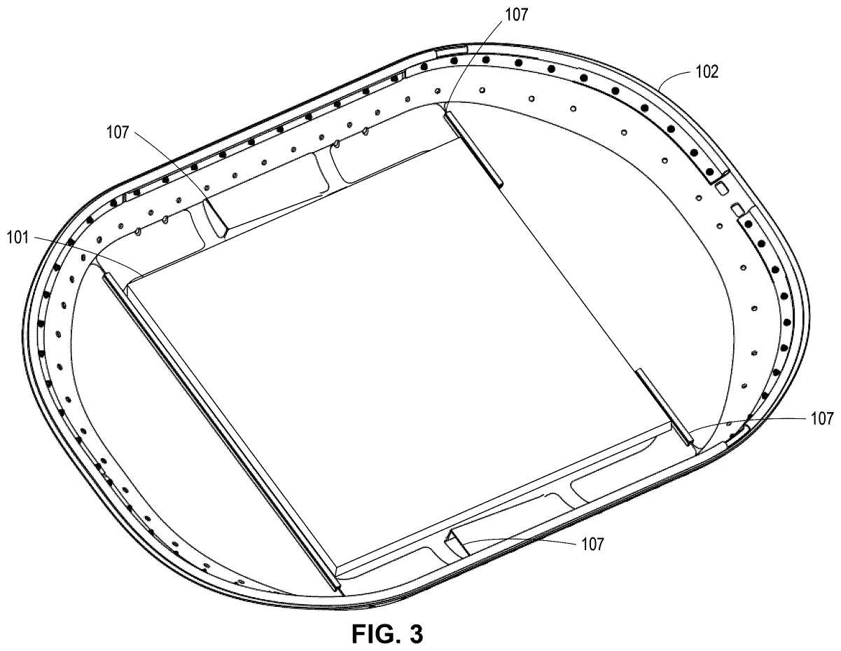

FIGS. 1A-1B in connection with FIGS. 2 and 3 depict an example apparatus 100 for coupling an antenna 101 to a vehicle. FIG. 2 is a view of the example apparatus 100 of FIGS. 1A-B with a fairing 102 removed to provide a detailed view of the antenna 101 resting on an underlying baseplate 103. FIG. 3 is a view of the underside of the fairing 102 and antenna 101 separated from the baseplate 103. The illustrated example includes the baseplate 103 to receive the antenna 101 including a plurality of mounting points 204, and the fairing 102 to be attached to the baseplate 103 to surround a peripheral edge 105 of the antenna 101. The apparatus 100 includes a first cavity 106 formed by the antenna 101, gussets 107 of the fairing 102, and a top surface of the baseplate 103. The apparatus 100 also includes a second cavity 108 including the remaining air volume outside the gussets 107 and within the fairing 102, and between a bottom surface of the baseplate 103 and a skin of the vehicle. The apparatus 100 further includes an opening 109 between the first cavity 106 and the second cavity 108. The first cavity 106 includes a first inlet 110, and an outlet 111 and the second cavity 108 includes a second inlet 112. The gussets 107 of the fairing 102 are configured to control air flow from the first inlet 110 and the second inlet 112 to the outlet 111. Some examples may include more than one opening 109.

In the illustrated example, the first inlet 110, the second inlet 112, and the outlet 111 also function as a drain to evacuate any fluid from the first cavity 106 and the second cavity 108. In some examples, the first cavity 106 and the second cavity 108 may include a plurality of inlets 110, 112 and outlets 111. Altering the number and size of the inlets 110, 112 and the outlets 111 allows for further tuning of the air exchange rate of the first cavity 106 and the second cavity 108, which may be beneficial depending on the application. In the illustrated example, the first inlet 110 and the second inlet 112 are located towards a rear of the vehicle, while the outlet 111 is placed towards a front of the vehicle so that as air passes over the apparatus 100 air is pulled from the first inlet 110 and second inlet 112 to the outlet 111 by a vacuum effect. In other examples, the first inlet 110 and second inlet 112 may be located toward the front of the vehicle and the outlet 111 may be located toward the rear of the vehicle. In the illustrated example, the outlet 111 has a first cross-sectional area greater than a combined second cross-sectional area of the first inlet 110 and second inlet 112. In other examples, the first-cross sectional area may be less than or equal to that of the combined second cross-sectional area. The opening 109 may be configured to tune the air exchange rate of both cavities 106, 108. In some examples, the gussets 107 may be configured to cause turbulence of the air in the first cavity 106 and the second cavity 108. Altering shapes of the gussets 107 may influence the pressure of the air beneath the antenna 101 and the dispersion of pressure beneath the antenna 101 in the event of a cabin decompression event such as that in an airplane. Specific antennas 101 may have different pressure requirements. The gussets 107, the opening 109, and the amount and size of the inlets 110, 112 and outlets 111 may be configured to meet specific requirements and applications.

In the illustrated example, the fairing 102 is fastened to the baseplate 103 by a plurality of mechanical fasteners, such as bolts, nuts, rivets, threaded inserts, etc. However, in other examples, the fairing 102 may be fastened to the baseplate 103 using an adhesive. In still other examples, the fairing 102 may be fastened to the baseplate 103 with a combination of fastening techniques. The baseplate of the illustrated example includes four mounting points 204. However, other examples may include a different number of mounting points 204 (1, 2, 3, 5, etc.). The baseplate 103 of the illustrated example includes a thermally conductive material such as aluminum. However, in other examples the baseplate 103 may include non-thermally conductive materials such as plastic. In the illustrated example, the baseplate 103 and the fairing 102 are configured to accept a square or rectangular antenna 101. However, in other examples the baseplate 103 and the fairing 102 may be configured to accept an antenna 101 that is of a different shape including circular, polygonal, irregular, etc.

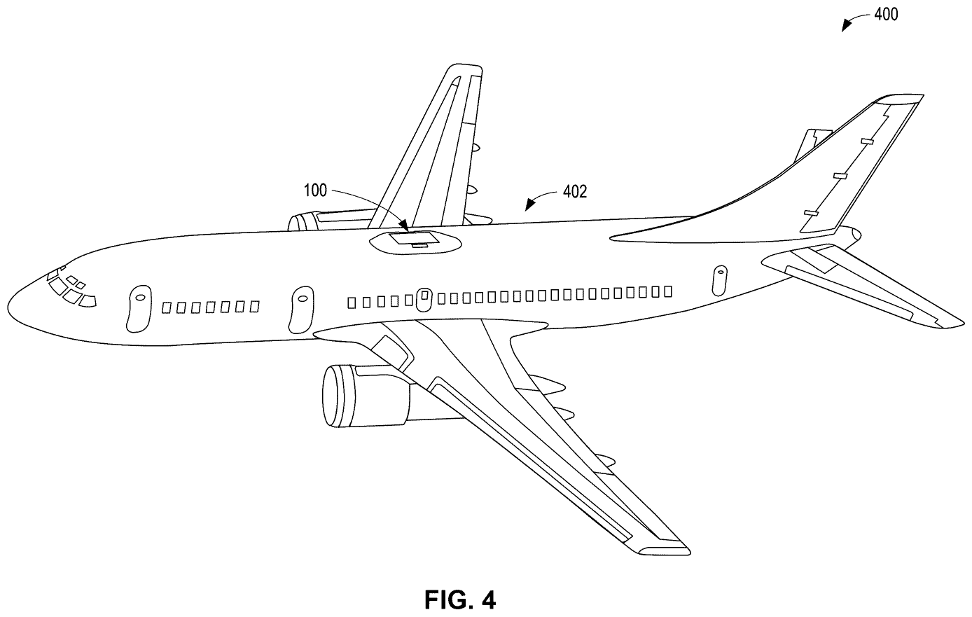

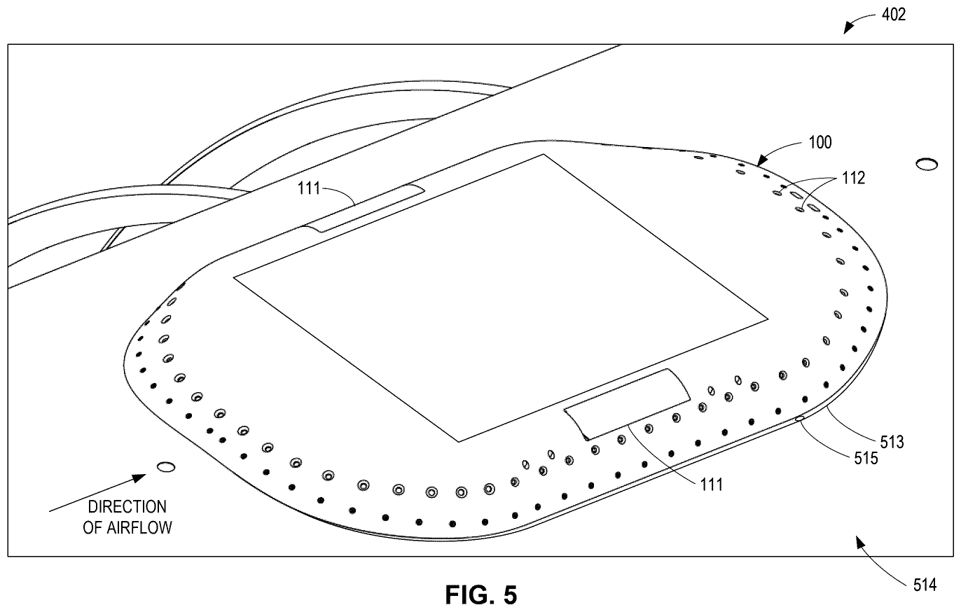

FIG. 4 in connection with FIG. 5 depict an example aircraft 400 including the apparatus 100 of FIG. 1 on a topside 402 of the aircraft 400. In the illustrated example, the apparatus 100 is positioned so that the first inlet 110 and second inlet 112 are oriented towards the aft end of the aircraft 400 while the outlet 111 is oriented towards the front of the aircraft 400. In the illustrated example, the gussets 107 (not shown), the opening 109 (not shown), the inlets 110, 112, and the outlets 111 are configured to adequately disperse pressure underneath the antenna 101 in the event of a cabin decompression event of the aircraft 400. The illustrated example includes a seal 513 between the fairing 102 and the fuselage 514. The seal 513 may include gaskets, liquid, or semi-liquid sealants, O-rings, etc. In some examples, the seal 513 prevents the ingress of fuel into the first cavity 106 and the second cavity 108. Further, the seal 511 includes a drain hole 515.

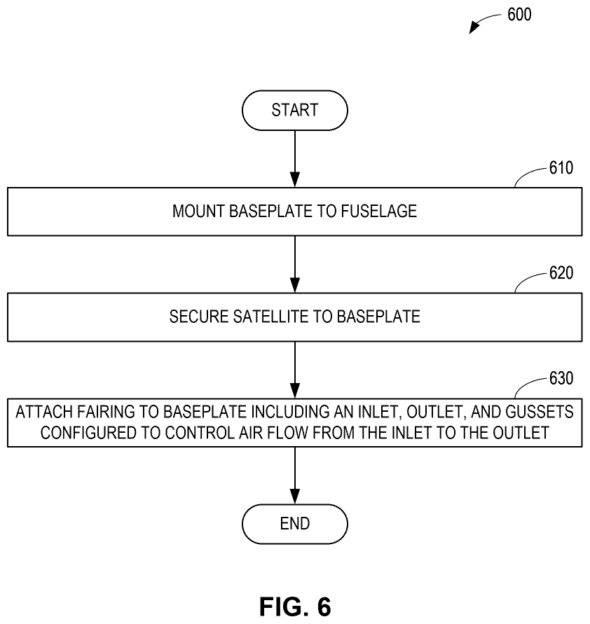

FIG. 6 is a flowchart of an example method 600 for securing an antenna to an aircraft. The example method for securing an antenna includes mounting a baseplate to a fuselage of the aircraft 610, securing the antenna to the baseplate 620, and attaching a fairing to the baseplate including walls configured to affect air flow from an inlet to an outlet 630. “Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

From the foregoing, it will be appreciated that example systems, apparatus, articles of manufacture, and methods have been disclosed that allow for mounting an antenna to a vehicle. Disclosed systems, apparatus, articles of manufacture, and methods are accordingly directed to one or more improvement(s) in the operation of an apparatus for mounting an antenna to a vehicle for use in high stress environments such as a military aircraft.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

Example 1 includes an apparatus for coupling an antenna to a vehicle including a baseplate to receive the antenna including a plurality of mounting points, a first cavity including a first inlet and an outlet, a second cavity including a second inlet, an opening between the first cavity and the second cavity, and a fairing to be attached to the baseplate to surround a peripheral edge of the antenna, the fairing including gussets configured to control air flow from the first and second inlet to the outlet.

Example 2 includes the apparatus of example 1, wherein the baseplate includes a thermally conductive material.

Example 3 includes the apparatus of example 1, wherein the outlet of the first cavity is a first outlet and further including a second outlet.

Example 4 includes the apparatus of example 1, wherein the first inlet, the second inlet, and the outlet also function as a drain.

Example 5 includes the apparatus of example 1, wherein the outlet has a first cross-sectional area greater than a combined second cross-sectional area of the first and second inlets.

Example 6 includes the apparatus of example 1, wherein the fairing is fastened to the baseplate by a plurality of mechanical fasteners.

Example 7 includes an aircraft including a fuselage including mounting points, a baseplate mounted to the fuselage via the mounting points, a satellite antenna fastened to the baseplate, a first cavity including a first inlet and an outlet, a second cavity including a second inlet, an opening between the first cavity and the second cavity, and a fairing to be attached to the baseplate to surround a peripheral edge of the antenna, the fairing including gussets configured to control air flow from the first and second inlets to the outlet.

Example 8 includes the aircraft of example 7, wherein the baseplate includes a thermally conductive material.

Example 9 includes the aircraft of example 7, wherein the outlet of the first cavity is a first outlet and further including a second outlet.

Example 10 includes the aircraft of example 7, wherein the outlet has a first cross-sectional area greater than a combined second cross-sectional area of the first and second inlets.

Example 11 includes the aircraft of example 7, wherein the fairing is fastened to the baseplate by a plurality of mechanical fasteners.

Example 12 includes the aircraft of example 7, further including a seal between the fairing and the fuselage.

Example 13 includes the aircraft of example 12, wherein the seal prevents the ingress of fuel into a cavity of the fairing.

Example 14 includes the aircraft of example 12, wherein the seal includes a fluid drain.

Example 15 includes a method for securing an antenna to an aircraft including mounting a baseplate to a fuselage of the aircraft, securing the antenna to the baseplate, forming a first cavity including a first inlet and an outlet, forming a second cavity including a second inlet, forming an opening between the first cavity and the second cavity, and attaching a fairing to the baseplate to surround a peripheral edge of the antenna, the fairing including gussets configured to control air flow from the first and second inlets to the outlet.

Example 16 includes the method of example 15, wherein the baseplate includes a thermally conductive material.

Example 17 includes the method of example 15, wherein the outlet has a first cross-sectional area greater than a combined second cross-sectional area of the first and second inlets.

Example 18 includes the method of example 15, wherein the outlet of the first cavity is a first outlet and further including a second outlet.

Example 19 includes the method of example 15, further including a seal between the fairing and the fuselage.

Example 20 includes the method of example 19, wherein the seal prevents the ingress of fuel into a cavity of the fairing.

What is claimed is:

1. An apparatus for coupling an antenna to a vehicle comprising:
a baseplate to receive the antenna including a plurality of mounting points;
a first cavity including a first inlet and an outlet;
a second cavity including a second inlet;
an opening between the first cavity and the second cavity; and
a fairing to be attached to the baseplate to surround a peripheral edge of the antenna, the fairing including gussets configured to control air flow from the first and second inlets to the outlet.

2. The apparatus of claim 1, wherein the baseplate includes a thermally conductive material.

3. The apparatus of claim 1, wherein the outlet of the first cavity is a first outlet and further including a second outlet.

4. The apparatus of claim 1, wherein the first inlet, the second inlet, and the outlet also function as a drain.

5. The apparatus of claim 1, wherein the outlet has a first cross-sectional area greater than a combined second cross-sectional area of the first and second inlets.

6. The apparatus of claim 1, wherein the fairing is fastened to the baseplate by a plurality of mechanical fasteners.

7. An aircraft comprising:
a fuselage including mounting points;
a baseplate mounted to the fuselage via the mounting points;
a satellite antenna fastened to the baseplate;
a first cavity including a first inlet and an outlet;
a second cavity including a second inlet;
an opening between the first cavity and the second cavity; and
a fairing to be attached to the baseplate to surround a peripheral edge of the antenna, the fairing including gussets configured to control air flow from the first and second inlets to the outlet.

8. The aircraft of claim 7, wherein the baseplate includes a thermally conductive material.

9. The aircraft of claim 7, wherein the outlet of the first cavity is a first outlet and further including a second outlet.

10. The aircraft of claim 7, wherein the outlet has a first cross-sectional area greater than a combined second cross-sectional area of the first and second inlets.

11. The aircraft of claim 7, wherein the fairing is fastened to the baseplate by a plurality of mechanical fasteners.

12. The aircraft of claim 7, further including a seal between the fairing and the fuselage.

13. The aircraft of claim 12, wherein the seal prevents the ingress of fuel into a cavity of the fairing.

14. The aircraft of claim 12, wherein the seal includes a fluid drain.

15. A method for securing an antenna to an aircraft comprising:
mounting a baseplate to a fuselage of the aircraft;
securing the antenna to the baseplate;
forming a first cavity including a first inlet and an outlet;
forming a second cavity including a second inlet;
forming an opening between the first cavity and the second cavity; and
attaching a fairing to the baseplate to surround a peripheral edge of the antenna, the fairing including gussets configured to control air flow from the first and second inlets to the outlet.

16. The method of claim 15, wherein the baseplate includes a thermally conductive material.

17. The method of claim 15, wherein the outlet has a first cross-sectional area greater than a combined second cross-sectional area of the first and second inlets.

18. The method of claim 15, wherein the outlet of the first cavity is a first outlet and further including a second outlet.

19. The method of claim 15, further including a seal between the fairing and the fuselage.

20. The method of claim 19, wherein the seal prevents the ingress of fuel into a cavity of the fairing.
